(19) United States
(12) Patent Application Publication
(10) Pub. No.: US 2006/0291324 A1
(43) Pub. Date: Dec. 28, 2006

(54) Screw for kneading extruder

(75) Inventors: Kazuhiro Kodate, Hiroshima-shi (JP); Shigeki Inoue, Hiroshima-shi (JP); Hisatoshi Tsushima, Hiroshima-shi (JP)

Correspondence Address: SUGHRUE MION, PLLC, 2100 PENNSYLVANIA AVENUE, N.W., SUITE 800, WASHINGTON, DC, 20037, US

(73) Assignee: THE JAPAN STEEL WORKS, LTD.

(21) Appl. No.: 11/455,185

(22) Filed: Jun. 19, 2006

(30) Foreign Application Priority Data
Jun. 27, 2005 (JP) P2005-186012

(51) Int. Cl. B29B 7/58

(52) U.S. Cl. 366/79

(57) ABSTRACT

A screw for a twin-screw kneading extruder comprises a screw shaft having spline grooves formed therein, and a plurality of screw segments adapted to be inserted on that screw shaft. The spline grooves of the screw segments are formed in the two end portions of the axial direction of the screw segments, while leaving the intermediate portions as relief portions, in which the spline grooves are not formed. Since the intermediate portions need not be machined, the screw can be manufactured highly precisely, even if the axial length of the screw segments is large, at a working cost as low as that for the short ones.

This application is based on Japanese Patent Application No. 2005-186012, which is incorporated herein by reference.

### BACKGROUND OF THE INVENTION

1. Field of the Invention

The present invention relates to a screw for a kneading extruder and, more particularly, to a screw, which is rotationally driven in a cylinder to knead and melt a resin material fed from one end portion of the cylinder and to extrude the resin material from the other end portion. The invention relates to a screw for a kneading extruder such as a screw for a twin-screw kneading extruder, although not limitative.

2. Description of the Related Art

A single-screw kneading extruder having one screw rotationally driven in a cylinder is well known in the art, although the document names are not enumerated. Also well known in the art is a twin-screw kneading extruder, which is constituted to include a cylinder and two screws so disposed in the cylinder as to be rotationally driven in the different directions or in the same direction. This twin-screw kneading extruder is schematically constituted, as shown in FIG. 2A, to include a cylinder 30, and two screws 40 and 40 disposed rotationally driven in the cylinder 30. This cylinder 30 is of the twin-hull type, in which two bores are formed in the axial direction. Moreover, the screws 40 and 40 are individually removably disposed in these individual bores. This cylinder 30 is provided near its left end portion, as shown in FIG. 2A, with a material feed port 31 for feeding a resin material into the cylinder 30, and near its right end portion with a vent port 32. Moreover, an extruding nozzle, although not shown, is disposed at the right end portion. Around the cylinder 30, on the other hand, there are disposed heaters, which are individually controlled in their heating temperatures.

The screws 40 and 40 are composed of screw shafts 41 and 41 and a plurality of screw segments 45, 45, . . . , and so on inserted on the screw shafts 41 and 41. These screw shafts 41 and 41 are splined or serrated in its outer circumference, although not shown. Alternatively, the screw shafts 41 and 41 are worked into a polygonal shape. The screw segment 45 is composed of a boss portion 46 and a flight formed integrally with that boss portion 46, as perspectively shown in FIG. 2B. According to the difference in the shape of the flight 47, although not shown, the screw segment 45 is divided into the Dulmage screw, the pin screw, the kneading disc and so on. In the center portion of the boss portion 46 of each of the screw segments 45, 45, . . . , and so on thus formed, there is axially formed a through hole of a predetermined shape to fit the screw shaft 41. This through hole matches the shape and size of the outer circumference of the screw shaft 41. In case the screw shaft 41 is the spline shaft, the through hole is formed to have spline grooves 48, 48, . . . , and so on, as shown in FIGS. 2B and 2C. In the case of the polygonal shape, on the other hand, the through hole is formed into a polygonal through hole 49, as shown in FIG. 2D.

The screw segments 45, 45, . . . , and so on having the flights 47 for performing the predetermined shape or the predetermined function are suitably selected and sequentially inserted on the screw shafts 41 and 41, and are fastened by fastening bolts 42 and 42 at the leading ends of the screw shafts 41. Then, the screws 40 and 40 are constituted to have a predetermined length in the axial direction. The state, in which the two screws 40 and 40 thus constituted are inserted into the cylinder 30, is shown in FIG. 2A. In FIG. 2: the portion on the left side acts as a feed compression section 33; the downstream side acts as a melting/kneading section 34; and the most downstream side acts as a devolatilizing booster section 35. Here, the screw segments 45, 45, . . . , and so on are shown in FIG. 2A to have the same shape, but kneading discs having a shape different from the shown one are disposed, for example, at the melting/kneading section 34.

Since the twin-screw kneading extruder is constituted, as described hereinbefore, the two screws 40 and 40 are rotationally driven, and the resin material is fed from the material feed port 31 to the feed compression section 33 of the cylinder 30. The resin material is fed sequentially from the feed compression section 33 through the melting/kneading section 34 to the devolatilizing booster section 35. At this time, the resin material is melted by the heat applied from the outer circumference of the cylinder 30 and by the heat of the resin material generated by the frictional action, by the shearing action and so on received from the screws 40 and 40, so that it is homogeneously mixed. The water content, the gas content and so on are discharged from the vent port 32 of the devolatilizing booster section 35, and the resin material is extruded from the extrusion nozzle.

Japanese Utility Model No. 2,500,532 and JP-A-5-220815 disclose such related twin-screw kneading extruder. In Japanese Utility Model No. 2,500,532, there is disclosed a screw, which is constituted to include a screw shaft and a plurality of screw segments or segment pieces inserted on the screw shaft. A guide groove is formed in the end faces of the segment pieces to mate the screw shaft. This guide groove extends radially outward from the outer circumference of the screw shaft and is opened in the inner circumference of the cylinder. As a result, the water content, the volatile content and so on, which might otherwise accumulate in the clearances between the screw shaft and the segment pieces while being kneaded and melted, are discharged through the guide groove to a material feeding hopper. As a result, air bubbles are prevented from being mixed into the molten resin. In JP-A-5-220815, on the other hand, there is disclosed a fastening method, in which screw segments are inserted on a screw shaft and in which fastening nuts or caps for fixing the inserted screw segments on the screw shaft are fastened by a pressure cylinder.

By the twin-screw kneading extruder of the related art, too, the resin material can be kneaded and melted and can be devolatilized, if necessary, and extruded, as described above, so that no special problem arises in the use. However, the kneading extruder of the related art may take a high cost for manufacturing or working the kneading extruder screw in dependence upon its constitution, and may have a high total cost. This rise in cost is reasoned in the following. The screw segments 45, 45, . . . , and so on have their through holes worked throughout the spline grooves 48, 48, . . . , and so on, as shown in FIGS. 2B and 2C. In case the ratio L/D between the axial length L and the bore diameter D of the screw segments 45, 45, . . . , and so on is small, that is, in case the axial length L is short, the spline grooves 48, 48, . . . , and so on an be worked relatively easily. As the axial length L becomes larger, the stroke of the cutting tool also becomes longer. Moreover, the groove working is made in the inner surfaces of the through holes so that the working cost rises. This rising cost also applied to the working of the serrated grooves or the polygonal through holes. This problem of the working cost for the screw segments 45, 45, . . . , and so on is neither intended for solution nor solved by the inventions described in Japanese Utility Model No. 2,500,532 and JP-A-5-220815.

### SUMMARY OF THE INVENTION

Therefore, the present invention has an object to provide a screw for a kneading extruder, which can be precisely manufactured at a relatively low cost even if the axial length of the screw segments constituting the screw of the kneading extruder becomes large.

The screw shaft 41 and the screw segments 45, 45, . . . , and so on are made, as described hereinbefore, to engage with each other by the spline grooves 48, 48, . . . , and so on. These engagements by the spline grooves 48, 48, . . . , and so on can transmit the high rotating force of the screw shaft 41 to the screw segments 45. Therefore, we have found out that the high rotating force need not be transmitted to the whole length of the screw segments 45, 45, . . . , and soon, and that the rotating force necessary for the kneading and melting operations can be transmitted by a predetermined length. When the screw segments 45, 45, . . . , and so on are sequentially inserted on the screw shaft 41 and are fastened by the fastening bolts 42, it is also found out that the vicinities of the end faces, at which the screw segments 45, 45, . . . , and so on contact with each other, are important for the strength. Thus, it is further found out that the aforementioned object of the present invention is achieved by selecting portions, i.e., the “relief portion or stealing portion”, in which the spline grooves 48, 48, . . . , are not formed, other than the vicinities of the end faces, so that the length to be worked is reduced even if the screw segments 45, 45, . . . , and so on have a long axial length.

In order to achieve the above-specified object, according to the first aspect of the invention, there is provided a screw for a kneading extruder comprising a cylinder, and a screw disposed rotationally driven in the cylinder, wherein a resin material being fed from one end portion of the cylinder is kneaded and melted, when the screw is rotationally driven, so that it is extruded from the other end portion. The screw is constituted such that the screw comprises a screw shaft comprising an engaging groove having a predetermined shape formed in an outer circumference of the screw shaft, and a screw segment adapted to be sequentially inserted on the screw shaft, the inner surface of the screw segment comprising an engaged groove which matches the engaging grooves of the screw shaft formed at each side of an axial direction of the screw segment, and a relief portion, in which the engaged groove is not formed, provided in an intermediate portion of the screw segment. In the screw of the kneading extruder according to a second aspect of the invention, the engaging groove is a spline groove.

According to the invention, as described hereinbefore, the screw is constituted such that the screw includes: a screw shaft having engaging grooves of a predetermined shape formed in its outer circumference; and a plurality of screw segments having engaged grooves matching the engaging grooves of the screw shaft and adapted to be sequentially inserted on the screw shaft, and such that the engaged grooves of the screw segments are worked at their two end portions of the axial direction of the screw segments while leaving their intermediate portions as relief portions, in which the engaged grooves are not formed. In short, the working range of the engaged grooves of the screw segments is limited so that the screw can be manufactured, even if the axial length of the screw segments is large, at a working cost similar to that for the shorter ones. Since the working length is short, moreover, another advantage obtained is that the screw segments of a long axial length can be provided without deteriorating the working precision.

### BRIEF DESCRIPTION OF THE DRAWINGS

FIGS. 1A to 1C are views showing a screw segment according to the invention, of which: FIG. 1A shows a perspective view of the section; FIG. 1B shows a sectional front elevation; and FIG. 1C shows a sectional view taken in the direction of arrows I-I of FIG. 1B; and

FIGS. 2A to 2C are views showing an example of the related art, of which: FIG. 2A shows a top plan view showing a twin-screw kneading extruder in section in the axial direction; FIG. 2B shows a perspective view of a screw segment; FIG. 2C shows a sectional view of the same; and FIG. 2D shows a sectional view showing a through hole of another shape of the screw segment.

### DETAILED DESCRIPTION OF THE PREFERRED EMBODIMENTS

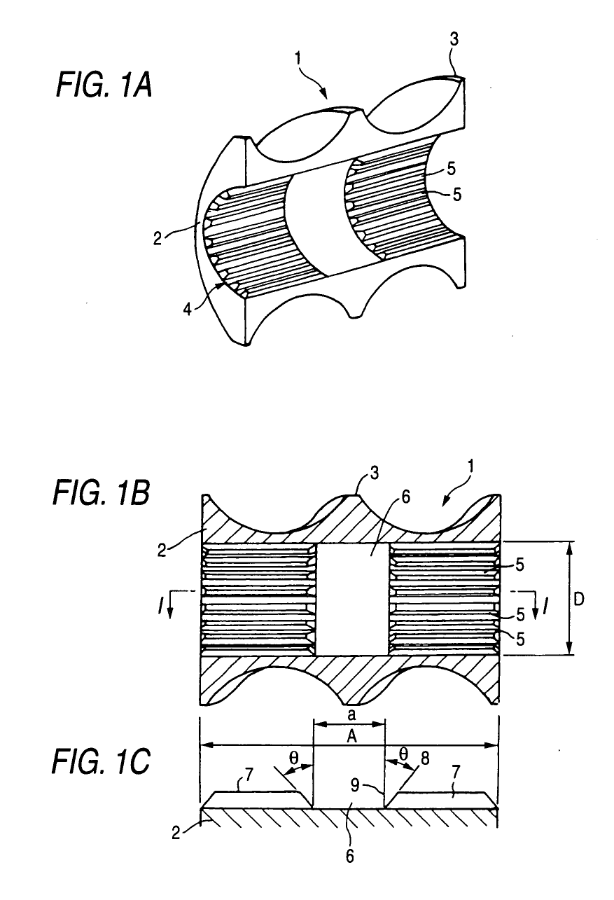

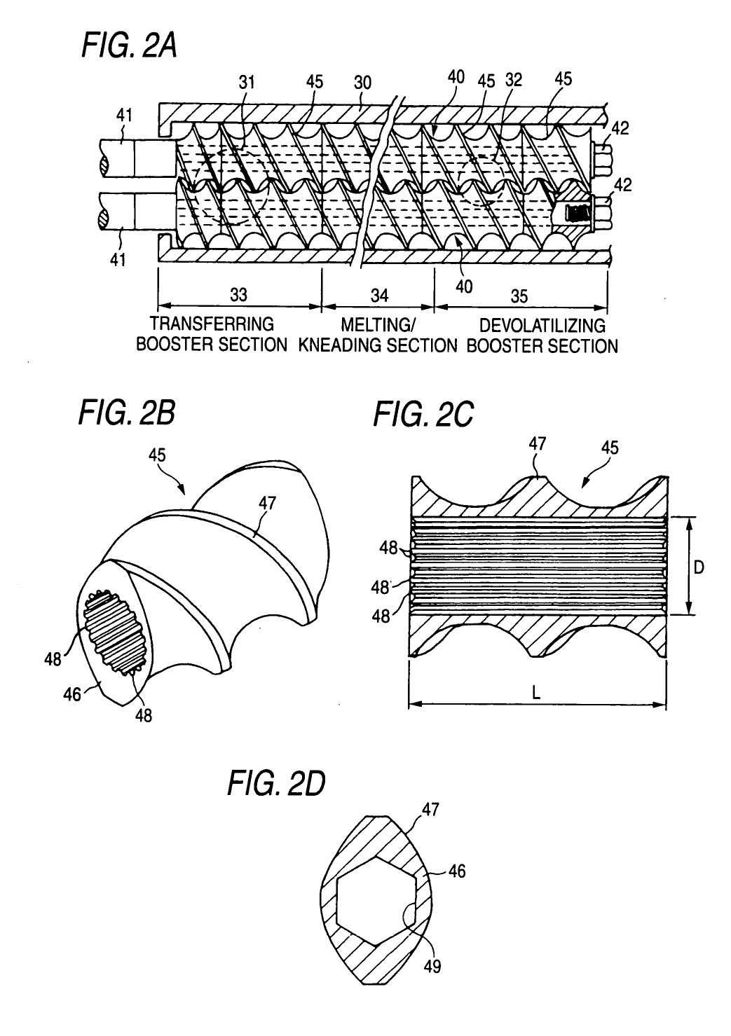

A mode of embodiment of the present invention is described with reference to FIG. 1. A screw segment according to this embodiment also has various flight shapes, as has been described with reference to FIG. 2. When the segment is suitably mounted on a screw shaft, a screw for an extruder having predetermined functions is constituted to have a predetermined length in the axial direction. However, only the screw segment having a standard flight is shown in FIG. 1.

A screw segment 1 according to this embodiment, as shown in FIG. 1, is also constituted to include a boss portion 2 and a spiral flight 3 formed integrally with that boss portion 2. In the center portion of the boss portion 2, there is formed a through hole 4 to be inserted on a screw shaft, as described hereinbefore. The screw segment 1 thus constituted has an axial length A, and the through hole has a diameter D. The ration A/D is made relatively large compared with the related art. In this embodiment, moreover, spline grooves 5, 5, . . . , and so on of the through hole 4 are formed in the two end portions of the screw segment 1 while leaving the center portion as a relief portion 6 or a stealing portion 6, in which spline grooves 5, 6, are not formed, over a predetermined length. This relief portion 6 is a portion not to engage with the spline grooves of the screw shaft so that it does not need any mechanical work to form the spline grooves. This relief portion 6 has such a length a as is not especially limited but selected to 1 to 70% (or 10 to 70%) of the axial length A in this embodiment by considering the transmission of a force from the screw shaft to the screw segment 1 according to the physical or chemical properties of the resin material to be treated and the amount of this treatment. As shown in FIG. 1C, moreover, the angle θ made between the end face 8 of a ridge 7 of the spline groove 5 positioned on the side of the relief portion 6 and a line 9 perpendicular to the axis is set to 10 to 90 degrees according to this embodiment. By this angle, the screw segment 1 can be easily inserted on the screw shaft.

According to this embodiment, the relief portion 6 is formed at the center portion of the screw segment 1. By inserting the screw segment 1 like the aforementioned one of the related art onto the screw shaft, the screw can be assembled, and the resin material can be likewise kneaded and melted so that it can be extruded. At this time, the rotating torque from the screw shaft can be transmitted to the screw segment 1 only through the portion having the screw segments 45, 45, . . . , and so on formed. It is apparent that the invention can also be likewise executed even on the serrated grooves or the polygonal shape.

What is claimed is:

1. A screw for a kneading extruder comprising:
a screw shaft comprising an engaging groove having a predetermined shape formed in an outer circumference of the screw shaft; and
a screw segment adapted to be sequentially inserted on the screw shaft, the inner surface of the screw segment comprising:
an engaged groove which matches the engaging groove of the screw shaft formed at each side of an axial direction of the screw segment; and
a relief portion, in which the engaged groove is not formed, provided in an intermediate portion of the screw segment.

2. The screw for a kneading extruder according to claim 1, wherein the engaging groove is a spline groove.

3. The screw for a kneading extruder according to claim 1, wherein the screw comprises a plurality of the screw segments.

4. The screw for a kneading extruder according to claim 1, wherein a length of the relief portion is selected from 1 to 70% of an axial length of the screw segment.

5. The screw for a kneading extruder according to claim 4, wherein the length of the relief portion is selected from 10 to 70% of the axial length of the screw segment.

6. A kneading extruder comprising:
a cylinder, and
a screw according to claim 1 which is disposed rotationally driven in the cylinder.
